(19) United States
(12) Patent Application Publication
(10) Pub. No.: US 2021/0187815 A1
(43) Pub. Date: Jun. 24, 2021

(54) TEMPERATURE CONTROL DEVICE FOR THE THERMAL CONDITIONING OF PREFORMS AND METHOD FOR OPERATING SUCH A TEMPERATURE CONTROL DEVICE

(71) Applicant: KHS Corpoplast GmbH, Hamburg (DE)

(72) Inventors: Bernd ZIMMERING, Hamburg (DE); Deniz ULUTÜRK, Hamburg (DE); Jens-Peter RASCH, Ahrensburg (DE); Daniel FIRCHAU, Mölln (DE); Christian MÜNDEL, Ammerbek (DE)

(21) Appl. No.: 16/761,299

(22) PCT Filed: Nov. 20, 2018
(86) PCT No.: PCT/EP2018/081937

§ 371 Date: May 4, 2020

(30) Foreign Application Priority Data
Nov. 27, 2017 (DE) 10 2017 010 970.2

(51) Int. Cl. B29C 49/78; B29C 49/12; B29C 49/66

(52) U.S. Cl. CPC B29C 49/786; B29C 49/12; B29C 49/66; B29C 2949/78663; B29C 2949/78151; B29C 2949/78386; B29C 2049/129

(57) ABSTRACT

The invention relates to a method for operating a temperature control device (116) for the thermal conditioning of preforms (14) made of a thermoplastic material in the temperature control device (116), wherein the respective preform (14) is prepared by the thermal conditioning in the temperature control device (116) for a subsequent forming procedure, in which the preform (14) is formed into a container (12) using a forming fluid supplied under a pressure into the preform (14) and in which the preform (14) is stretched in its axial direction by a stretching unit (11), wherein the temperature control device (116) is regulated in its heating power by a heating regulator (400, B) on the basis of a metrologically determined guide value, and is characterized in that a guide value is metrologically detected, from which the stretching force exerted on the preform (14) is derivable. Furthermore, the invention relates to a temperature control device (116) for the thermal conditioning of preforms (14) made of a thermoplastic material which is regulated on the basis of the guide value, wherein the guide value is derived from the stretching force exerted by the stretching unit (11). Finally, the invention relates to a container production machine having a temperature control device as defined above.

The invention relates to a method for operating a temperature control device for the thermal conditioning of preforms made of a thermoplastic material according to the preamble of claim 1. The invention furthermore relates to a temperature control device for the thermal conditioning of preforms according to the preamble of claim 8. Finally, the invention relates to a machine for producing containers from preforms according to the preamble of claim 13.

The production of containers by blow molding from preforms made of a thermoplastic material, for example, from preforms made of PET (polyethylene terephthalate), is known, wherein the preforms are supplied to different processing stations within a blow molding machine (DE 4340291 A1). A blow molding machine typically comprises a temperature control device for the temperature control and/or thermal conditioning of the preforms and a blowing device having at least one blowing station referred to as a forming station, in the region of which the respective previously temperature-controlled preform is expanded to form a container. The expansion is performed with the aid of a compressed gas (generally compressed air) as a forming fluid or pressure medium, which is introduced at a molding pressure into the preforms to be expanded. The method sequence in the case of such an expansion of the preform is explained, for example, in DE 43 40 291 A1. The fundamental structure of a blowing station is described, for example, in DE 42 12 583 A1. Possibilities for the temperature control of the preforms are explained, for example, in DE 23 52 926 A1. Temperature control or thermal conditioning is understood in this case to mean that the preform is heated to a temperature suitable for the blow molding and possibly a temperature profile adapted to the contour of the container to be produced, for example, is applied to the preform. The blow molding of containers from preforms with additional use of a stretching rod is also known.

According to a typical further processing method, the containers produced by blow molding are supplied to a downstream filling unit and filled here with the provided product or filling material. A separate blowing machine and a separate filling machine are thus used. However, combining the separate blowing machine and the separate filling machine to form a machine block, i.e., to form a blocked blowing-filling unit is also known in this case, wherein the blow molding and the filling still take place on separate machine components and in chronological succession.

Producing containers, in particular also in the form of bottles, from thermally-conditioned or temperature-controlled preforms and in this case filling them simultaneously with a liquid filling material, which is supplied as a hydraulic forming fluid or pressure medium for expanding the preform and/or for forming the container at a forming and filling pressure, so that the respective preform is formed into the container simultaneously with the filling, has also already been proposed. Such methods, in which simultaneous molding and filling of the respective container is performed, can also be referred to as a hydraulic forming method or as hydraulic container molding. Assisting this forming by way of the use of a stretching rod is also known here. The preform is also firstly thermally conditioned here before the forming and filling procedure.

In the case of forming of the container from the preform by the filling material itself, i.e., using the filling material as a hydraulic pressure medium, only one machine is still required for the forming and filling of the container, which has an increased level of complexity for this purpose, however. One example of such a machine is disclosed in U.S. Pat. No. 7,914,726 B2. A further example is disclosed in DE 2010 007 541 A1.

With respect to the thermal conditioning of the preforms, the requirements are essentially identical independently of whether in a following step the forming of the preform provided with a suitable temperature profile is carried out by means of introduction of a pressurized gas or by means of a pressurized liquid. The respective temperature control device to be provided for the thermal conditioning of the preforms and the respective method to be applied for operating such a temperature control device are thus equivalent for both known forming methods. The invention described hereafter relates similarly to both described forming methods and the machines and temperature control devices used in this case.

Temperature control devices known in the prior art consist, for example, of multiple so-called heater boxes. These heater boxes are typically arranged stationary along a heating line and preforms are moved through these heater boxes by means of suitable transport units and heated at the same time. Typical transport units consist, for example, of a circulating transport chain. The chain links are formed in this case, for example, by transport mandrels, each of which holds a preform by clamping engagement in the mouth section of a preform and guides it on its circulating movement along the heating line and through the heater boxes.

In general, the temperature control device is constructed modularly, i.e., multiple such heater boxes are arranged as heating modules along the heating line. These can each be identical heater boxes in this case or heater boxes of different constructions.

Heating elements are arranged inside the heater boxes, for example. Near infrared radiators (NIR) are preferably used as heating elements in the prior art, for example, multiple near infrared radiators can be arranged one over another as heating elements in the longitudinal direction of a preform. EP 2 749 397 A1 or also W2011/063784 A2 show one example of such a temperature control device and one example of the typical structure of a heating module referred to above as a heater box.

It is known in the prior art that these temperature control devices are connected to a control unit. This control unit is generally designed in this case such that the preforms are heated inside the temperature control device such that they leave the temperature control device having a desired temperature profile. This is to be understood to mean that both a defined temperature is implemented in the preform and also a defined temperature profile in the longitudinal direction of the preform and possibly also in the circumferential direction of the preform. A temperature profile can also be provided in the radial direction, i.e., inside the wall thickness of the preform.

It is also known in the prior art that, for example, in addition to the above-mentioned heating elements, units can also be provided for cooling the surface of the preforms, for example, units for the targeted application of a cooling airflow to the preform surface. These additional units for cooling can also be incorporated into the mentioned control unit of the temperature control device. The concept of the control unit and the control method comprises units and methods using which a control is executed in the meaning of the English term “open-loop control”, using which a regulation is executed in the meaning of the English term “closed-loop control”, and mixed forms thereof. According to the invention, this relates to the regulation of a temperature control device in the meaning of the English term “closed-loop control”, so that reference is made in the claims to a regulation and a heating regulator.

To be able to regulate and/or control the temperature control device by control technology such that the preforms are provided thermally conditioned in the desired manner at the outlet of the temperature control device, i.e., they have the desired temperature and the desired temperature profile, arranging, for example, a measurement sensor at the outlet of the temperature control devices known in the prior art, for example, a pyrometer, which detects the surface temperature on preforms running past the measurement sensor. The guide value of the regulation in such an embodiment would be the surface temperature of the preforms. This measured value can be compared, for example, to a target value and the regulation of the temperature control device can thus be set to a regulation to a target value for the surface temperature of the preforms.

In known temperature control devices, it is sometimes provided that a differentiation is performed with respect to heating elements arranged one over another in the longitudinal direction of the preforms. A separate heating power is defined, for example, for each of the heating elements arranged one over another, which is regulated and/or controlled by the control unit. For example, preset can be performed in the control unit, for example, by an operator, as to whether and in which way heating elements arranged at different height levels are to heat differently. The control unit can provide for this purpose, for example, a height-specific parameter. Furthermore, it is known that a superordinate power parameter is set, which is applied for all heating elements. The actual heating power specified by the control unit of a radiator level, i.e., all heating elements arranged at an equal height level, then results by multiplication of both parameters. A defined heating profile is settable by the individual setting of the heating power per heating element level. Thus, for example, the heating power in each level can be set so that specific regions of the preform are more strongly heated. At the same time, the heating power can be set overall via the superordinate power parameters shared by all heating elements. The regulation of the temperature control device is performed in this case in the prior art in that the superordinate power parameter is adjusted in dependence on the pyrometer measured value. The pyrometer measured value represents the guide variable of the regulation, i.e., for example, the surface temperature of the preforms. The height-specific parameter is not regulated in most cases in the prior art, but rather results from the desired temperature profile in the axial direction of the preform. It is typically set during the configuration and/or during the breaking in of the machine and is changed as needed by an operator, for example, in the event of a production changeover to other preforms.

Metrologically detecting the wall thickness of finished blown containers and using these measured values as the guide variable of the heating regulation is also known in the prior art. WO 2010/054610 A1 and WO 2007/110018 A1 are examples of this prior art, in which the height-selective regulation of the heating power on the basis of associated sensors is also described.

The temperature prevailing in the temperature control device is metrologically detected in the prior art, for example, by temperature sensors, which can be arranged, for example, in a reflector of the temperature control device. Such a temperature measurement can be used, for example, to establish whether the temperature control device has reached a defined target temperature, from which the introduction of the preforms into the temperature control device is started. It is also possible to provide multiple such temperature sensors.

The above-described methods for regulating a temperature control device are considered still to be in need of improvement for various reasons. A pyrometer measurement is performed, for example, on the preform outer surface, the temperature of which can certainly deviate substantially from the temperature of the preform inner surface, however. This results, for example, from the fact that the thermal radiation acts by absorption in the preform, and the absorption is greatest on the preform outer surface, since the thermal radiation is firstly incident there and loses intensity falling exponentially during the penetration of the preform. Thermal equalization processes do take place. The thermoplastic materials typically used for the preforms usually have a poor thermal conductivity, however, so that temperature differences only balance out slowly. Changing environmental conditions can also influence the external temperature, for example, the startup of the machine or interruptions in the production operation. The external temperature of the preform upon leaving the temperature control device therefore does not always sufficiently accurately reflect the energy content and the energy distribution in the preform, which define, however, the material distribution in the finished formed containers and thus the container properties. A regulator having the guide variable preform temperature is not considered to be sufficiently robust against interfering variables. The metrological detection of wall thicknesses is linked to some measurement expenditure and is already in need of improvement for this reason. An earlier detection of the guide value than after total completion of the forming procedure would also be desirable.

The present invention is to effectuate an improvement at this point and is to improve the quality of the thermal conditioning of the preforms and thus also the quality of the containers produced therefrom. The robustness of the regulation against interfering variables is also to be improved.

This object is achieved by a method according to claim 1 and/or according to claim 7, by a temperature control device according to claim 8, and by a machine according to claim 13. Further advantageous features are specified in the dependent claims.

It is provided in the core concept of the invention that the regulation of the thermal conditioning of the preforms is carried out on the basis of the guide variable stretching force. The thermal conditioning takes place in the temperature control device, so that the regulation of this device is carried out according to the invention according to a guide value, which has such a direct relationship to the physical variable stretching force that it may be derived therefrom. On the one hand, it is possible to detect the stretching force directly by arranging corresponding force measuring units. On the other hand, it is possible to measure a value from which the stretching force can be computed, for example, with knowledge of further variables or by application of mathematical methods. This value preferably has a proportionality relationship to the stretching force. For the purposes of the regulation, the stretching force does not necessarily actually have to be derived from the detected values. The detected values can also be used directly to regulate the temperature control device, in particular if a proportionality exists, in particular if a linear proportionality exists.

In the case of mechanically driven stretching units, for example, stretching rods, a direct measurement of the stretching force can be metrologically detected, for example, via strain gauges. In the case of hydraulically or pneumatically driven stretching rods, for example, the metrological detection of the pressure of the drive media results in a variable from which the stretching force is derivable. However, in particular the measurement by means of a stretching rod provided with strain gauges and associated measurement technology is very complex. The stretching unit, in particular the stretching rod, therefore preferably has an electrical stretching system which offers the option of current measurement. The stretching force can thus be inferred from the current measurement without additional measurement equipment.

The regulation according to the invention of the temperature control device according to the stretching force cannot be confused with the regulation as described in EP 2 117 806 B1 in paragraph [0057] therein. The stretching force is used there to regulate a parameter of the blowing process, which is only executed after the thermal conditioning, however. These explicitly relates to the regulation of the blowing pressure therein, which is also directly related to the stretching force, because less stretching force is to be applied upon elevation of the blowing pressure and vice versa. There is no point of contact with the regulation of the thermal conditioning in EP 2 117 806 B1. Both above-mentioned processes together, i.e., the thermal conditioning and its regulation and the forming process and its regulation, merely jointly result in the production method to create a container from a preform. Both processes are to be considered separately with respect to regulation.

Multiple types of stretching units are known in the prior art. The use of a stretching rod has prevailed in large part in practice. It is therefore advantageously proposed that the stretching unit is a stretching rod driven by an electric stretching rod drive, in particular by a servo motor or linear motor, wherein the current consumption of the electrical stretching rod drive is metrologically detected. Metrologically simple conditions are then provided and the metrologically easily detectable current of the servo motor or linear motor also permits the conclusion of the applied stretching force.

It is preferable in the sense of a simple regulation implementation that only specific characteristic values of the stretching force profile and/or the guide value profile are used for the regulation, for example, local maxima in the curve profile. It is also preferable, for example, for the stretching force curve or the guide value curve to be integrated over a defined range to make the foundation of the regulation a stretching energy or guide value energy resulting therefrom. Multiple of these preferred values can also be taken. This also applies for the case in which the detected measured values are not converted into a stretching force, but rather are used directly for the regulation. The use of the above-mentioned characteristic values and/or an integral over a defined measured value range is also preferable in this case.

The regulation of the thermal conditioning can be improved still further in that an external temperature of the preforms is metrologically detected and supplied to the heating regulator as a second guide value. The temperature control device comprises, on the one hand, heating units for heating the preforms and cooling units for applying a coolant medium to the preforms. In this case, the cooling units, for example, fans, and the heating units, for example, thermal radiators, are each regulated by the heating regulator on the basis of different guide values, in particular, the cooling units are regulated on the basis of the guide value external temperature and the heating units are regulated on the basis of the guide value stretching force and/or a variable related thereto. A reversal of this regulation association is also implementable in the scope of the present invention, however. A dynamic equilibrium and a stable temperature conditioning may be set well by simultaneous heating and cooling. In particular, in this manner a temperature profile can also be set in the radial direction in the preform, i.e., within the preform wall.

Since the stretching force is directly related to the material distribution in the finished container and thus to the container properties, it is preferable for the heating regulator to prioritize the guide value stretching force or the guide value from which the stretching force is derivable over the guide value external temperature.

The drive of the stretching rod not only has to apply the stretching force, but rather also compensate for friction losses which occurred due to the stretching rod movement, for example, at seals through which the stretching rod is guided. To improve the regulation, it is therefore advantageous if these friction forces are metrologically detected and taken into consideration in the regulation, for example, by the detected current values being filtered of the friction component. The friction losses may be detected, for example, by executing no-load strokes of the stretching rod and metrologically detecting them. During a no-load stroke, the stretching rod movement is executed without preform. Friction losses may also be taken into consideration in that the region of the stretching force curve or the guide value curve is considered in which the acceleration of the stretching system against its inertia is completed, but stretching of the preform has not yet begun. The execution of no-load strokes is considered to be preferable, since those items of information about friction losses are obtainable over the entire stretching travel of the stretching rod, while these friction losses are superimposed in the other described case in the regions of the acceleration of the stretching system and the stretching of the preform with the effectively used forces and separation is not possible between friction losses and acceleration and/or stretching forces.

It can be advantageous to subject the metrologically detected values, for example, to filtering for smoothing, before the regulation is based thereon as a guide value.

The above explanations apply similarly to the devices according to the invention.

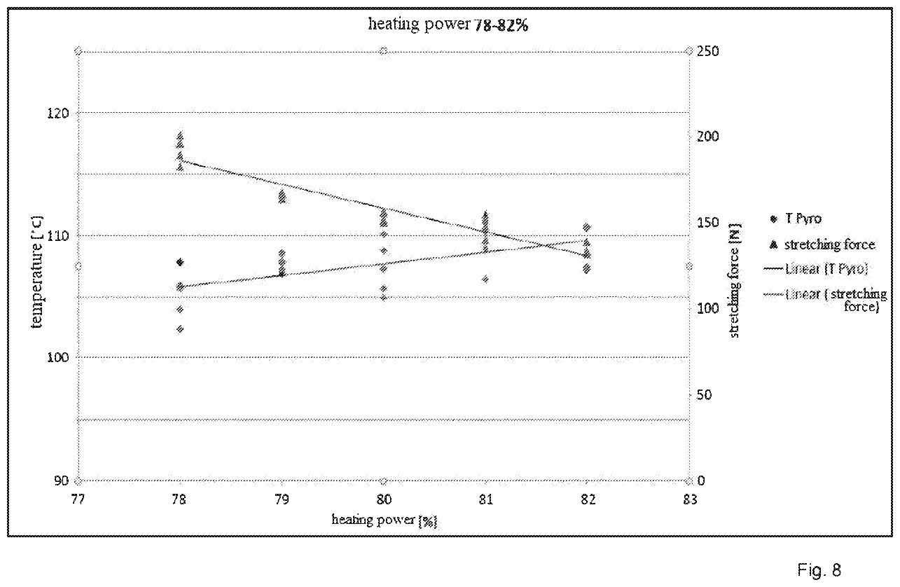

The fact that the stretching force or a guide value from which the stretching force is derivable is fundamentally suitable to be used as a guide value for a regulation of the temperature control device results, for example, from the strain hardening property of PET, wherein PET stands here as a representative and without restriction of the generality for the class of thermoplastic materials, which have also heretofore been used for the forming production of containers from preforms. PET is solely an example of a particularly suitable thermoplastic preform material. This is because it can be concluded from the strain hardening property that the forces occurring during the forming process play an important role in the later properties of the formed container. On the one hand, the pressure of the forming fluid introduced into the preform acts as a force on the preform, on the other hand, the force, for example, of a stretching rod acts, which guides the resulting container bubble and exerts a stretching force. It has been established on the basis of experiments that the stretching force exerted by the stretching rod, for example, is very sensitively linked to the properties of the finished container, see FIG. 8.

A metrologically simple detection of the guide value stretching force or a guide value derivable from which the stretching force is derivable is possible, for example, if a stretching rod driven by an electrical drive is provided. One example of such a stretching rod having electrical stretching rod drive can be found, for example, in above-mentioned EP 2 117 806 B1. In the servo motor disclosed therein, for example, by means of the motor current, the spindle pitch, and the torque constant of the motor K_{Φ}, the force in the direction of the preform longitudinal axis can be ascertained from F(t)=(i(t)−K_{Φ}·2π)/spindle pitch. The motor current itself is a variable which is already suitable as a guide value, since the stretching force is derivable therefrom, namely by computation. The stretching force is even linearly proportional to the current in a good approximation.

Further advantages, features, and details of the invention result from the exemplary embodiments described hereafter with reference to schematic drawings. In the figures:

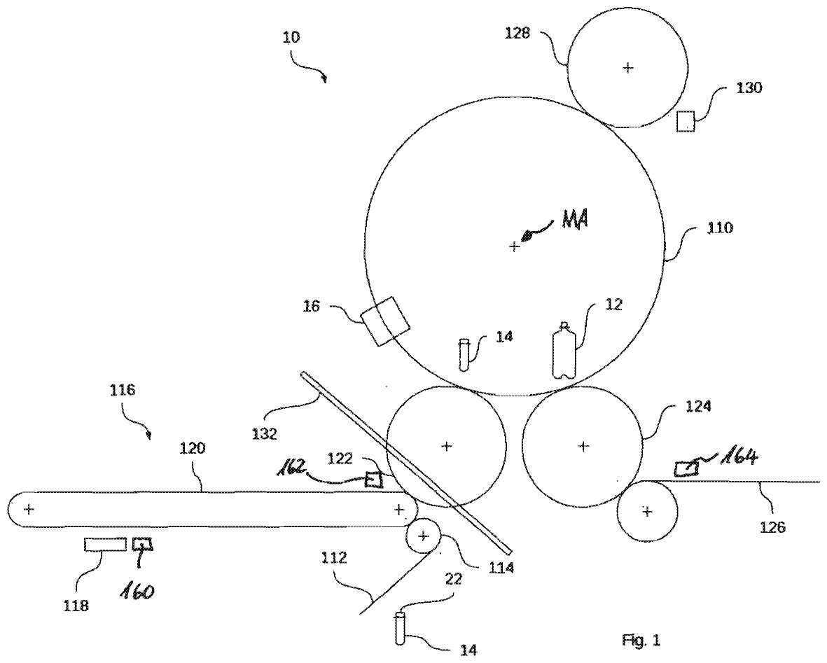

FIG. 1 shows a very schematic illustration of a forming machine or a machine for forming containers from preforms,

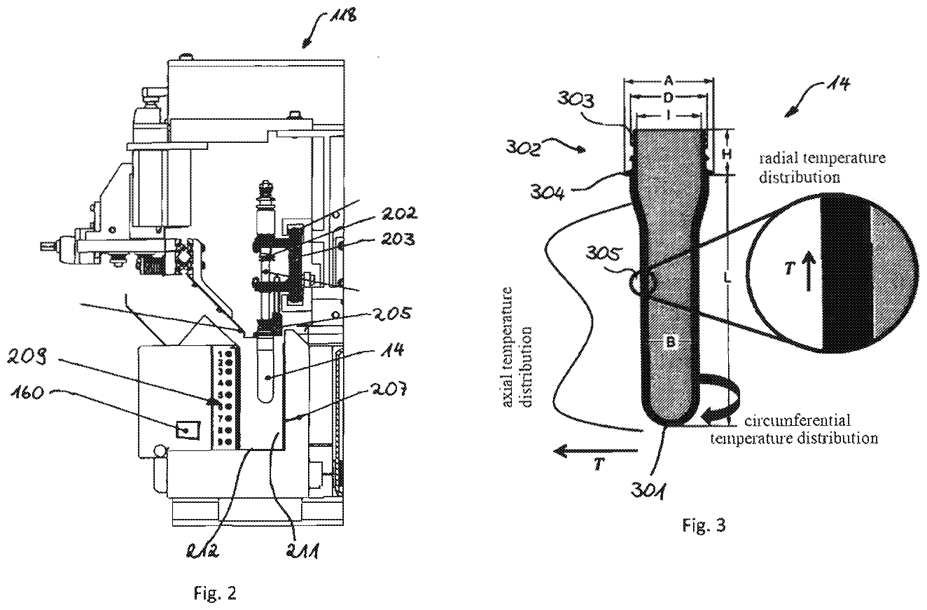

FIG. 2 shows a schematic illustration of a heater box of a temperature control device,

FIG. 3 shows a schematic illustration of a thermally-conditioned preform having temperature profiling,

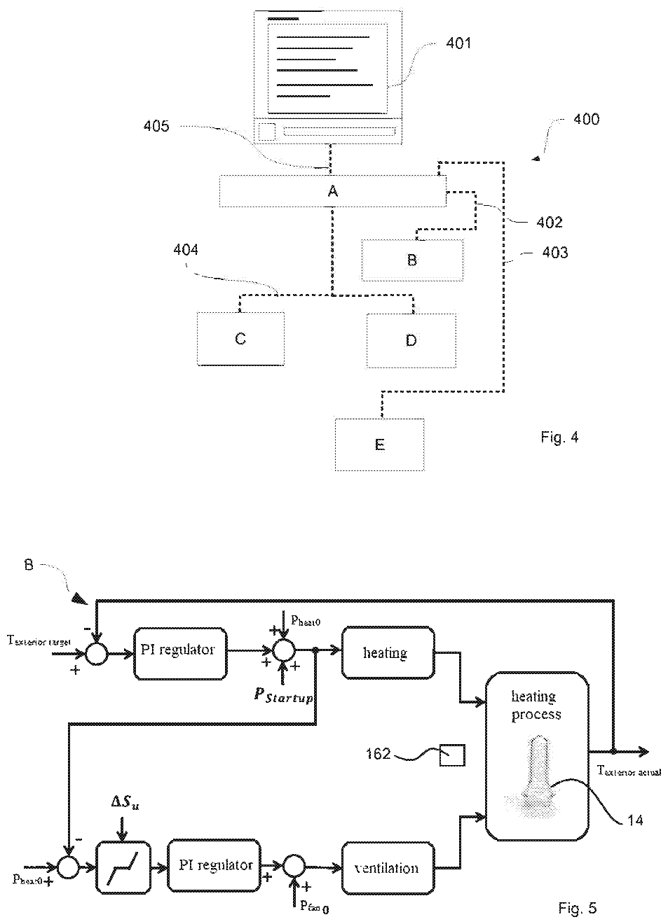

FIG. 4 shows a schematic illustration of a possible control architecture of a forming machine,

FIG. 5 shows a known regulation scheme for the regulation of a temperature control device,

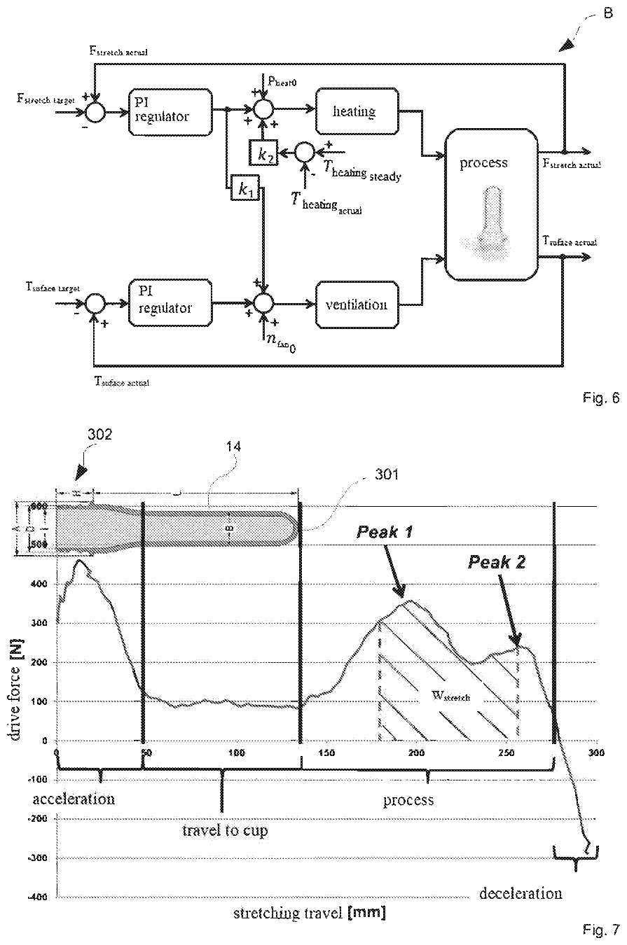

FIG. 6 shows a regulation scheme according to the invention for the regulation of a temperature control device,

FIG. 7 shows a schematic illustration of a stretching force curve in dependence on the stretching travel,

FIG. 8 shows a schematic illustration of the relationship between heating power of the temperature control device and detected external temperature of the preform, on the one hand, and between heating power of the temperature control device and detected stretching force, on the other hand,

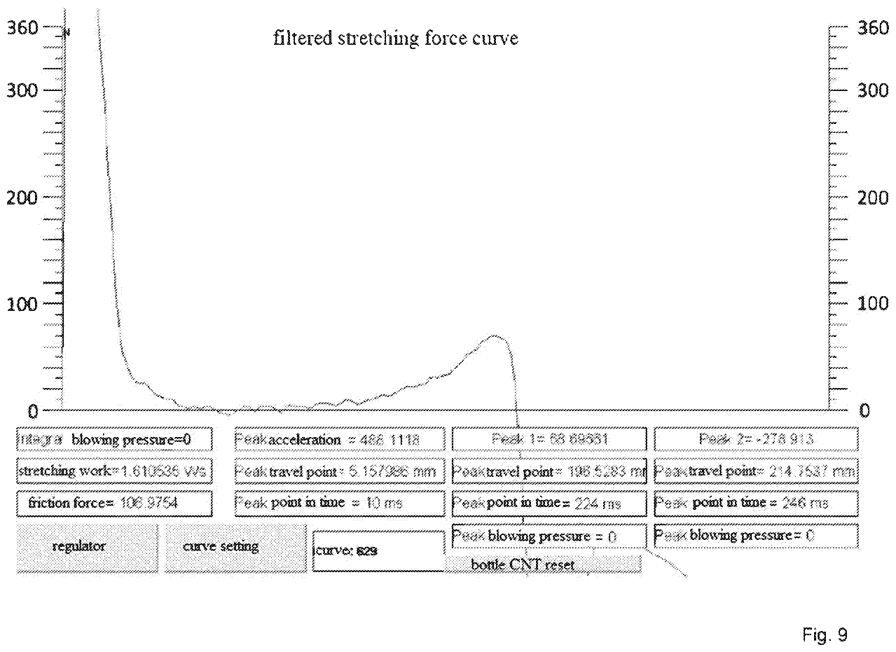

FIG. 9 shows an example of a filtered stretching force curve during a no-load stroke of the stretching rod,

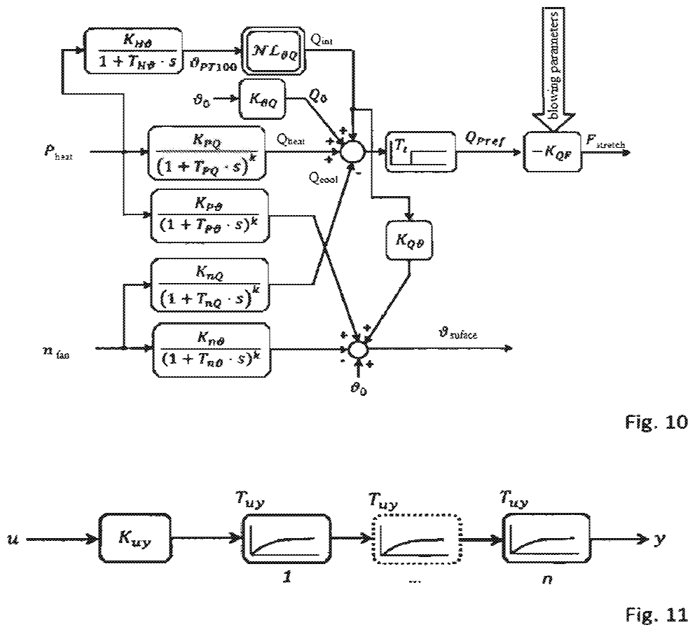

FIG. 10 shows a block diagram of regulation relationships during the regulation of a temperature control device including an interfering variable compensation,

FIG. 11 shows a block diagram of a PT-n element,

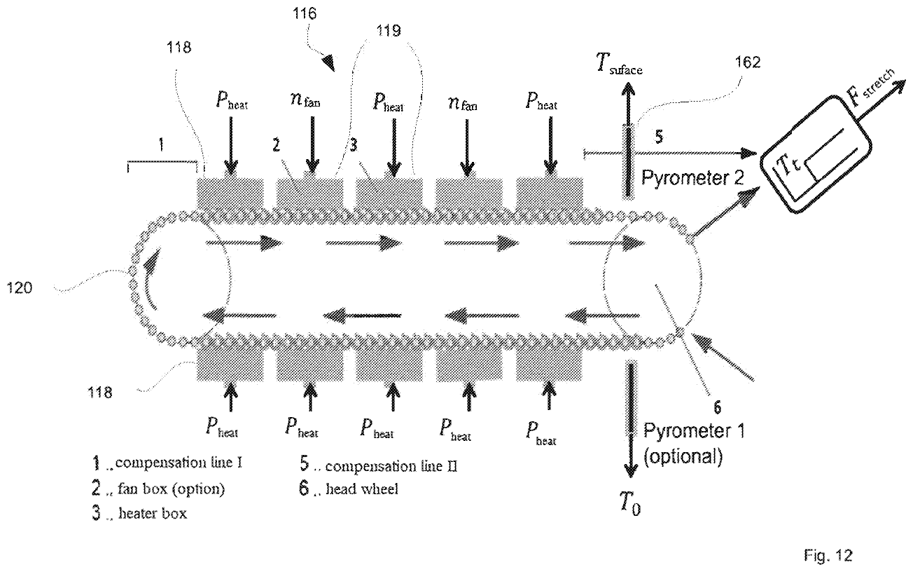

FIG. 12 shows a schematic illustration of a temperature control device to explain regulation variables,

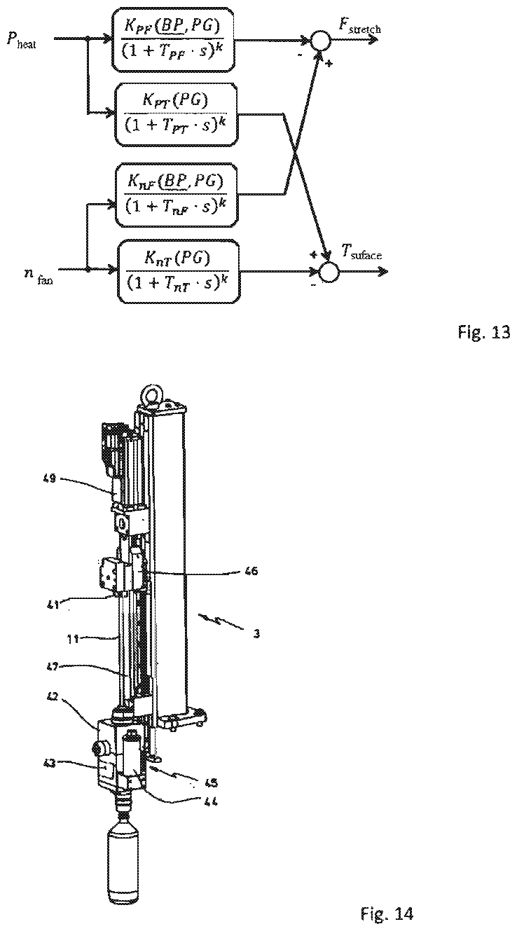

FIG. 13 shows a block diagram of a simplified control loop for a temperature control device which corresponds to FIG. 10 without interfering variable compensation, and

FIG. 14 shows a perspective side view of a blowing station as an example of a forming station, in which a stretching rod is positioned by an electrical drive.

The fundamental structure known from the prior art of a forming machine 10 is shown in FIG. 1. The illustration shows the preferred design of such a forming machine 10 as a type of a rotation machine having a rotating working wheel 110 supporting multiple forming stations 16. However, only one such forming station 16 is shown to simplify the drawing. Schematically shown preforms 14, which are also referred to as blanks, are continuously supplied by a supply unit 112 to a temperature control device 116 using a transfer wheel 114. In the region of the temperature control device 116, which is also referred to as a furnace and in which the preforms 14 are transported along a heating line and thermally conditioned at the same time, the preforms 14 can be transported depending on the application, for example, having the mouth sections 22 thereof upward in the vertical direction or downward in the vertical direction. The temperature control device 116 is equipped, for example, with heating units 118, which are arranged along a transport unit 120 to form the heating line. For example, a circulating chain having transport mandrels for holding the preforms 14 can be used as the transport unit 120. For example, heater boxes having IR radiators or light emitting diodes or NIR radiators are suitable as heating units 118. Since such temperature control devices are known in manifold types in the prior art, and since the design details of the heating units are not essential for the present invention, a more detailed description going beyond the description of FIG. 2 and FIG. 12 can be omitted and reference can be made to the prior art, in particular to the prior art for temperature control devices of blowing and stretch-blowing machines and for temperature control devices of forming and filling machines which are all comprised by the term forming machines.

After sufficient thermal conditioning, the preforms 14 are transferred by a transfer wheel 122 to a drivable working wheel 110, which is arranged so it is capable of rotation, i.e., revolving around a vertical machine axis MA, or to forming stations 16 which are arranged distributed around the circumference on the working wheel 110. The working wheel 110 is equipped with a plurality of such forming stations 16, in the region of which both forming of the preforms 14 into the schematically illustrated containers 12 and also filling of the containers 12 with the provided filling material take place. The forming of each container 12 takes place simultaneously with the filling in this case, wherein the filling material is used as a pressure medium during the forming. In blowing machines, in contrast, no filling takes place on this working wheel 110, but rather at a later point in time on a filling wheel having filling stations.

After the forming and filling, the finished formed and filled containers 12 are removed by a removal wheel 124 from the working wheel 110, transported further, and supplied to an output line 126. The working wheel 110 revolves continuously in the production operation at a desired revolution speed. During one revolution, the insertion of a preform 14 into a forming station 16, the expansion of the preform 14 to form a container 12 including filling with a filling material and possibly including stretching, if a stretching rod is provided, and the removal of the container 12 from the forming station 16 take place. A stretching unit, for example, a stretching rod, is provided for executing the present invention.

According to the embodiment in FIG. 1 it is furthermore provided that schematically shown closure caps 130 are supplied to the working wheel 110 via an input unit 128. In this way, it is possible also to already carry out closing of the containers 12 on the working wheel 110 and to handle finished formed, filled, and closed containers 12 using the removal wheel 124.

Different thermoplastic materials can be used as the material for the preforms 14. Polyethylene terephthalate (PET), polyethylene (PE), polyethylene naphthalate (PEN), or polypropylene (PP) are mentioned by way of example. The dimensioning and the weight of the preforms 14 are adapted to the size, the weight, and/or to the design of the containers 12 to be produced.

A variety of electrical and electronic components are typically arranged in the region of the temperature control device 116. In addition, the heating units 118 are provided with moisture-sensitive reflectors. Since filling and forming of the containers 12 using the liquid filling material takes place in the region of the working wheel 110, it is preferably to be ensured to avoid electrical problems that an inadvertent introduction of moisture into the region of the temperature control device 116 is avoided. This can be performed, for example, by a partition unit 132, which offers at least a spray protection. In addition, it is also possible to temperature control transport elements used in the region of the transfer wheel 122 for the preforms 14 suitably or to apply pressurized gas bursts to them in such a way that adhering moisture cannot reach the region of the temperature control device 116.

Handling of the preforms 14 and/or the containers 12 is preferably carried out using tongs and/or clamping spikes or mandrels to be applied at least in regions from the inside or from the outside to the mouth section 22 with a retaining force. Such handling means are also well-known from the prior art.

The forming machine 10 is equipped with measurement sensors for the purpose of its control and/or for the purpose of its regulation. It is thus typical, for example, for a temperature sensor 160 to be arranged in the temperature control device 116 in order to be able to measure a temperature of the temperature control device 116. Furthermore, it is known in the prior art that on the outlet side of the transport unit 120, which revolves clockwise, a temperature sensor 162 is arranged, which is designed, for example, as a pyrometer and detects a surface temperature, for example, on thermally-conditioned preforms 14 running past. Finally, performing measurements on finished containers 12 using measurement sensors is also known in the prior art. Thus, for example, a wall thickness measurement sensor 164 can be arranged on the output line 126 to detect the wall thickness of a container guided past it. The above-mentioned sensors can also be formed in this case by multiple sensors arranged vertically offset, for example, to carry out a temperature measurement along the preform longitudinal axis or, for example, to execute a wall thickness measurement along the container longitudinal axis. Multiple temperature sensors 160 can also be arranged in the temperature control device 116.

The heating unit 118 illustrated by way of example in FIG. 1 could appear, for example, as shown in greater detail in a schematic sectional view in FIG. 2. Such heating units are also referred to as heater boxes. In general, multiple of these heater boxes 118 are arranged adjacent to one another along the heating line to form a heating tunnel, through which the preforms 14 are guided.

The heater box 118 shown in a schematic sectional view in FIG. 2 comprises multiple near-infrared radiators 209, in the illustrated exemplary embodiment, nine near infrared radiators 209 are arranged one over another in the vertical direction and each of these near-infrared radiators 209 defines a heating level. These NIR radiators 209 can if needed all be operated at the same power or also at different powers individually or grouped in multiples. Depending on the axial extension of the preform 14, lower-lying radiator levels in the vertical direction can also be switched off. To achieve a temperature profile in the preforms 14, it is generally necessary for near infrared radiators 209 on different radiator levels to be operated at different heating powers.

A counter reflector 207, which reflects thermal radiation incident thereon back in the direction toward the preform 14 and thus back into the heating tunnel 211, is arranged opposite to the near-infrared radiators 209. The heating tunnel 211 is terminated on the bottom by a bottom reflector 212. The preform 14 is protected against thermal radiation on the mouth side by a support ring shield 205, since the mouth region having thread formed thereon is supposed to be protected from unnecessary heating. The support ring shield 205 is arranged in this case on the handling unit 203, which can be part of a circulating chain as explained with respect to FIG. 1. The handling unit 203 furthermore comprises a clamping mandrel 202, which engages in a clamping manner in the mouth section of the preform 14. Such clamping mandrels 202 and such handling units 203 are well-known from the prior art and do not require further explanation. The fundamental structure of this above-described heater box 118 is also known from the prior art.

The temperature sensor 160 schematically shown in FIG. 1 is also shown in the heater box 118 of FIG. 2, wherein this temperature sensor 160 is generally arranged behind a reflector, for example, behind the rear reflector 207. This temperature sensor 160 detects a temperature of the heater box 118. In principle, it would also be possible to detect a temperature inside the heating tunnel 211 or to perform a temperature measurement on the preform 14 inside the heating tunnel 211.

FIG. 3 shows a sectional view of a typical preform 14 having a closed bottom region 301 and an open mouth region 302. An external thread 303 and a support ring 304 are formed in the region of the mouth section 302. After completed thermal conditioning, a defined temperature distribution results in the preform 14. Thus, for example, a temperature profile as shown on the left side of the preform 14 can be generated by corresponding heating in the axial direction of the preform 14. It can be seen therein that a higher temperature is implemented in the bottom region and in a region below the support ring than in a region lying in between. However, it is also possible to heat the preform homogeneously in the axial direction. It is obvious from the enlarged portion of the wall region 305 that a temperature curve can also be set or is intentionally settable inside the preform wall. This is because, inter alia, the absorption of the thermal radiation results in stronger heating on the radial outside than on the radial inside. Temperature differences in the preform wall do cancel out with time due to thermal equalization processes. These temperature equalization processes are, however, relatively slow in the preforms, which typically consist of PET.

In addition, the preforms 14 can also be provided with a temperature profile in the circumferential direction. This is known, for example, for preforms which are subsequently to be shaped into non-round containers, for example, into oval containers.

FIG. 4 shows the schematic illustration of a possible modular control architecture of a control unit 400 for a forming machine 10. A master controller is identified by the letter A, letter B identifies a control unit for the control and/or regulation of a temperature control device, letter C identifies a controller for the drive, for example, of the working wheel 110, letter D identifies safety units, for example, emergency stop switch, and letter E identifies, for example, a control unit for the forming process, i.e., for example, for the possible drive of a stretching rod, for switching valves for switching on and off a forming fluid, etc. Control-relevant data can be displayed on a display screen 401 and the display screen 401 is supplied with values to be displayed by the master controller via a data line 405. The display screen 401 can also function as an input unit and values input via this input unit can be transferred via the connecting line 405 to the master controller A. The further data lines 402, 403, and 404 and data line 405 can be embodied, for example, as a data bus and are used, for example, for transferring data between the master controller A and the further control modules or mutually between the control modules.

FIG. 5 shows the schematic structure of a control unit B, which is fundamentally known in the prior art, for the heating regulator, wherein the surface temperature Tₑₓₜₑᵣᵢₒᵣ of a preform is selected as a guide value. The temperature control device regulated by this illustrated regulation operates using heating units 118 and using cooling units 119 in the form of a fan. The regulation receives a starting heating power P_{beat0} and a starting fan power P_{fan0} as operating points, since cooling of the preform surface is provided in the present case in addition to thermal radiators. The regulation of the temperature conditioning is to be carried out in this case on the basis of the measurement of a surface temperature of the preforms 14, and for this purpose, as explained with respect to FIG. 1, a pyrometer 162 is arranged at the end of the heating line. On the basis of the surface temperature T_{exterior, ACTUAL} of the preforms 14 measured using the pyrometer 162, the regulator adjusts the heating power of the heating units 118. Furthermore, it can be provided that an ambient temperature is detected and this ambient temperature is also incorporated into the regulation of the temperature control device. It is provided in the illustrated exemplary embodiment that sinking of the heating power is detected. To prevent excessively strong sinking of the heating power, if the power □S_{U} is undershot, the power of the surface cooling by the cooling units 119 is changed. Upon sinking of the heating power, for example, the power of the surface cooling is increased until the heating regulator establishes sinking of the surface temperature of the preforms and increases the heating power again.

FIG. 6 schematically shows an example of a heating controller according to the invention having a control unit B for the heating regulation using two guide variables and using two manipulated variables. A variable F_{stretch, ACTUAL}/F_{stretch, TARGET} is selected as the first guide variable, namely the stretching force or a variable from which the stretching force is derivable, or a variable determined therefrom, for example, the deformation work. A variable T_{surface, ACTUAL}/T_{surface, TARGET} is selected as the second guide variable, i.e., the surface temperature of a preform. On the one hand, the heating power Pₕₑₐₜ of the heating units 118 of the temperature control device and, on the other hand, the cooling power P_{fan} of the cooling units 119 are selected as manipulated variables. To enhance the robustness of the regulation, the regulation architecture shown in FIG. 6 is designed as a decentralized multivariable regulator.

To improve the transient behavior of the temperature control device, a feedforward control k₂ is integrated into the regulator according to FIG. 6. This adds, in dependence on the difference between the ACTUAL furnace temperature T_{furnace, ACTUAL} and the stable furnace temperature T_{furnace, stable}, i.e., the furnace temperature after reaching the thermal equilibrium state after a defined operating duration, an additional percentage power with a factor to the equilibrium heating power Pₕₑₐₜ₀, Pₕₑₐₜ₀ represents a base value. Before reaching the equilibrium state of the temperature control device or the furnace, a higher heating power thus results, to nonetheless bring the preforms to the desired temperature. The block diagram shown in FIG. 6 furthermore provides a decoupling branch k₁ to attenuate internal couplings. In the illustrated exemplary embodiment, the guide variable F_{stretch, ACTUAL}/F_{stretch, TARGET} is prioritized over the guide variable F_{surface, ACTUAL}/F_{surface, TARGET}. The feedforward control is shown in the block diagram as interference k₂, which is made dependent on the difference between the temperature of the temperature control device T_{furnace, stable} upon the presence of equilibrium conditions in relation to the actual temperature of the temperature control device T_{furnace, ACTUAL}. The greater this temperature difference is, the greater the interference effect is to be formed and therefore the higher the factor should be selected to increase the heating power in relation to the base heating power.

The heating power Pₕₑₐₜ₀ and the fan power P_{fan0} represent set powers for these actuators and describe an operating point or a base point. These powers are changed in dependence on the guide variables.

According to the invention, a regulation on the basis of a metrologically detected variable is provided, which is derivable from a stretching force or is the stretching force itself. A regulation according to variables determined therefrom can also be provided, for example, on the basis of the stretching force. Therefore, it is to be explained hereafter on the basis of an example how this variable can be respectively provided for the regulation.

FIG. 7 shows a metrologically detected stretching force curve, which was derived from the current consumption of the stretching rod drive, namely a servo motor. The stretching force is plotted over the stretching travel of the stretching rod, wherein stretching force is not yet exerted on the preform until the preform cup is reached by the stretching rod. Stretching thus does not yet take place on this travel section. Because of the mass inertia of the motor armature of the servo motor, the gearing, and the stretching rod, the acceleration and deceleration are also visible in the illustrated force curve. At the beginning of the stretching travel, the mass of the stretching system is accelerated. If the stretching rod has reached constant speed, in the illustrated case at approximately 50 mm, friction forces become visible. These results, on the one hand, from the gearing of the drive, on the other hand, from the friction forces of the stretching rod surface on seals. These seals seal off the part of the forming station to which pressure is applied from the surroundings. If the stretching rod contacts the cup, the stretching force increases. This takes place at a stretching travel of approximately 140 mm in FIG. 7. After the P1 valve has been switched, the stretching force drops again, since the internal pressure in the preform also generates an axial force, recognizable at the stretching force drop at a stretching travel just below 200 mm at the point peak1. With progression of the container bubble development, the strain hardening of the preform material appears as a rise of the drive force curve toward a second local maximum in the stretching force curve at peak2. So as not to collide with the base mold of the forming station, the stretching rod has to decelerate at the end of the P1 phase. The braking force required for this purpose is overlaid with the force which is to be applied for the actual stretching.

For example, the first and/or the second peak (peak1 and/or peak2) or also an integral over a range of the stretching force curve, for example, arranged essentially between these two peaks, is suitable for the use as a guide value. Such an integral represents stretching work. The forming process during the forming of a preform into a container is, in simplified form, the introduction of forming energy into a preform to produce a container. This forming energy is divided into thermal energy (temperature control of the preform) and into mechanical energy (radial and axial expansion of the preform). If one introduces more thermal energy, less mechanical work is necessary for the forming.

The mechanical forming work is composed of the application of a forming fluid to the preform at a defined forming pressure and/or having a defined volume flow and of the force applied by the stretching rod. The force applied by the stretching rod can be determined as stated above by metrological detection of the motor current.

The suitability of the second peak as a guide value is illustrated and explained hereafter. The measurement results compiled in FIG. 8 were achieved in studies using this second peak as the guide value. For example, the relationship of the second peak to the heating power during the thermal conditioning was studied, i.e., the change in peak2 with changed heating power. It is also indicated for comparison in FIG. 8 how the surface temperature of the preform is dependent on the changed heating power. FIG. 8 shows in the case of this comparison that the stretching force reflects the heating power introduced into the preform, i.e., the thermally introduced energy content, with higher accuracy than the previously used surface temperature detected by a pyrometer. With rising surface temperature and/or with rising heating power, the stretching force sinks as expected. While the stretching force sinks by 42% (by 55 N) upon the performed change in the heating power, the surface temperature only decreases upon the same change by 3.5% (by 3.8° C.). The stretching force thus proved to be more sensitive with respect to the heating power than the surface temperature.

FIG. 10 shows a block diagram to illustrate essential regulation-theoretical regulation relationships in the thermal conditioning process. The attempt is intentionally made in this case to describe the guide variables F_{stretch} and T_{surface} separately. To avoid confusions between time constants and temperatures, ϑ is used hereafter for temperatures. The master value of the heating power Pₕₑₐₜ and the speed of the fan n_{fan} (in % of the maximum speed) are used as inputs into the system. The surface temperature of the preform ϑ_{surface} is measured by means of the pyrometer 162 at the end of the heating line. In the chronologically following blowing process, a stretching force F_{stretch} is measured (or a variable from which the stretching force is derivable). It results from the amount of energy contained in the preform Q_{preform} after the temperature conditioning process and the factor K_{QF}. This factor is dependent on the settings of the blowing parameters. If one increases the blowing pressure, for example, the stretching rod guides the bubble less. It thus also becomes less sensitive to variations in the energy content in the preform as a result of the thermal conditioning.

The time between leaving the heating and measuring the stretching force is described from the aspect of the energy content as the dead time T_{f}. An energy loss due to convection does occur during this time, however, the energy content only changes insignificantly and can therefore also be neglected in regulation.

The energy Q_{preform} contained in the preform is decisively determined by the energy Qₕₑₐₜ introduced by the temperature control device. The energy Q_{cool} is removed by the surface cooling. If the temperature control device is in a steady operating state, which is achieved after a heating time, surrounding components are heated and emit longwave secondary radiation, which introduces the interference energy Q_{interference} into the preform. This interference energy also acts on the surface temperature by way of the factor K_{Qϑ}. Since the process is set to the steady state of the temperature control device, an absence of this energy results in deviations in the process, since the preform does not have the total energy required for the blowing process. The amount of secondary radiation which is emitted may be estimated by the temperature of the reflector plate ϑ_{PT100}. However, since the relationship between energy Q_{interference} and ϑ_{PT100} is not accurately known, it is described by the nonlinear relationship NL_{ϑQ}. The temperature ϑ_{PT100} results with a PT-1 behavior in dependence on the heating power Pₕₑₐₜ. Due to the good absorption of the longwave secondary radiation, it has influence on the surface temperature of the preform. This is depicted by means of the factor K_{Qϑ}. It describes how the surface temperature also changes due to the interference energy.

The entry temperature of the preform ϑ₀ is a further source of interference. This can change depending on the storage of the preform. If it rises, the surface temperature and the energy content thus also increase.

Upon an increase of the heating power, the preform located in the last heating module receives less additional energy because of the short remaining dwell time in the temperature control device. A preform which is just at the beginning of the temperature control device at the point in time of the power increase, in contrast, will already have the full additional energy content. Since every preform can be viewed as an energy accumulator between these two cases, it is obvious that a higher-order transmission behavior without harmonics results.

Since this observation is also carried out for the surface cooling, the main dynamics of the temperature control device are represented by 4 PT-n elements having degree k.

FIG. 11 shows a block diagram of such a PT-n element. A PT-n consists in this case of a series circuit of n PT-1 elements having the time constant T_{uy}. The transmission element has an amplification K_{uy} in this case. The individual PT-n elements are coupled according to P-canonical form.

FIG. 12 illustrates the arrangement of heating units 118 and of cooling units 119 along the heating line 120 and the incorporation thereof into the regulation of the temperature control device 116 on the basis of the specified parameters for heating powers and for fan speeds. It is clear by way of example from this overview where and when which parameter has influence on the thermally-conditioning effect of the temperature control device. Qualitatively, it can be stated that the time behavior of the surface cooling will always be somewhat faster than the time behavior of the heating modules. Because of the shorter line, the dynamics decay faster after manipulated variable change of the surface cooling than those of the heating line. The time which a fan or a heating module requires after change of the speed with the heating power, respectively, to set it is assumed to be negligible.

A model of the control loop suitable for the regulator of the temperature control device has been described with respect to FIG. 10. FIG. 13 shows a base regulator without interference variable compensation, i.e., the interference variables mentioned with respect to FIG. 10 are neglected here. Furthermore, the dead time at the transfer Tₜ and also the factor K_{QF} are depicted by means of the four transmission elements in P-canonical form. The factors K_{PF}(BP) and K_{nF}(BP) are introduced for the effect of the heating power and the surface cooling. They are dependent on the blowing parameter vector BP. If the blowing parameters are constant, the factors are thus also constant.

Since the temperatures and forces are dependent on the energy state of the preform, it may additionally be established that the amplifications K_{uy} in FIG. 13 are dependent on the dwell time in the temperature control device. This is defined by the production speed PG. If they are reduced, all factors increase, since the preform remains longer in each module. It can be presumed in a good approximation for regulation, for example, that this influence is linear around the operating point.

The base regulator is supposed to regulate the surface temperature and the stretching force as guide values. The heating units and the surface cooling still remain actuators. The use of a decentralized regulator enables a simple implementation.

Since the stretching force has a better correlation to the container quality than the surface temperature, it is preferably used as the manipulated variable for the temperature control device.

It is indirectly possible using the guide variables stretching force and surface temperature to specify the radial temperature profile in the preform. If the energy content (stretching force) is kept constant, the temperature in the interior of the preform has to rise upon reduction of the surface temperature. The internal temperature may thus be specified or maintained indirectly using this mode of action of the regulator.

The control loop described with respect to FIG. 10 is shown as a block diagram in FIG. 6. Since the temperature control device also strongly influences the surface temperature, a static decoupling is provided with k₁. A decoupling branch from surface temperature to temperature control device is avoided. The change of the surface temperature does have an effect on the stretching force, but the significance of the surface temperature with regard to the quality of the container is less. Therefore, control actions of the surface cooling are not supposed to be transferred directly to the heating power.

For example, the first or second peak and the stretching work can be selected as guide variables. Since all three variables describe the energy content in the preform after the thermal conditioning, in the above explanations, all three possible guide variables are described under the term “stretching force” and/or F_{stretch}. The stretching work is considered to be preferable as the guide variable, since it takes into consideration the entire process sequence during the forming.

To approximately compensate for the transient state of the temperature control device, i.e., the state before reaching a thermal equilibrium, the deviation from the already known stable temperature is connected as power to the temperature control device by the factor k₂. An improvement of the startup behavior can thus also be achieved using the base regulator explained with respect to FIG. 13 by means of empirical setting.

Pₕₑₐₜ₀ and n_{fan0} represent the powers set in the formula for the actuators and therefore describe the operating point. The signs in the subtraction are exchanged in comparison to the standard controller. This results from the relationships described hereafter. Thus, a higher heating power reduces the stretching force, and a greater airflow cools the surface more strongly.

Δheating power˜−Δstretching force

Δairflow˜−ΔT_{surface}

Since the essential interfering factors such as ambient temperature or soiling of the temperature control device only change very slowly, low dynamic requirements for the regulator result therefrom. The steady accuracy of the process, and thus a constant container quality in the course of the container production, has priority.

To achieve static accuracy, because of the non-integrating property of the main control loops, I components are provided in both regulators. To additionally achieve better dynamics of the closed-loop, PI regulators are used. The use of a PID regulator is precluded, since the D component can be selected to be very small because of the process noise, so as not to cause the control loop to oscillate.

Several main functions of the regulator are described hereafter, for example, how the guide variables stretching force can be generated.

Upon the start of the stretching, the stretching force, the stretching travel, and the bottle interior pressure are recorded. After ending the process, these measurements series are transmitted by means of an OPC interface to a computer for visualization. This computer processes the data, for example, for the export as a CSV file. The curve can thus be manually analyzed thereafter. However, the real-time analysis of the curve in the form of a guide value is necessary for the described regulator.

To ascertain the stretching force, the effective value of the current of the last millisecond is output in each case by the stretching rod drive. This is computed on a drive-internal FPGA, which also ensures the position regulation by means of a cascade regulation having guide variable generator. At a sampling rate of 1 ms, a large information loss thus does not result, since the entire time range is detected by effective value formation of the last millisecond. Due to the motor-internal effective value formation, noise caused by the converter is already filtered out. However, the generated stretching force curve is still subject to a substantial noise component. Therefore, filtering with a discrete PT1 filter is provided as the first, although optional step.

As explained with respect to FIG. 7, various ranges in the stretching force curve may be utilized for regulation. However, the range in which the friction occurs is also relevant. The two peaks and the stretching work are particularly relevant as possible guide values for the stretching-force-based part of the regulator. These values are sought out and/or determined in defined ranges. The ranges in which these are determined are set, for example, in dependence on the stretching travel.

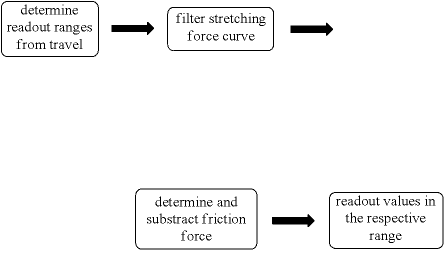

The above image shows the fundamental sequence of an exemplary algorithm. It is firstly identified in which ranges of the data the values to be ascertained and/or the friction are located. The noise is subsequently reduced by means of a discrete PT1 filter. The mean friction force is now determined. This occurs after the acceleration of the stretching rod during the constant travel up to the incidence on the cup of the preform. This force is subtracted as an offset from the curve, since it results from friction losses. The determination of the maxima and of the stretching force integral are now performed. To specify ranges in the stretching force curve for the respective variables, the travel of the stretching rod is used. This is also recorded with the same resolution as the stretching force. This travel is used as the x axis of the stretching force curve to define in which region the friction force occurs, the peaks are located, and the stretching work is to be determined. The regions can overlap in this case.

The algorithm passes through the array in which the travel is recorded and determines the index of the respective travel range limits. The stretching force curve is subsequently traversed value by value. If the value is located between the limits, the maximum deflection (in positive or negative direction) and the stretching work are determined for the peaks.

The ranges can be set manually, for example, or an automated definition of the positions of the peaks can also be performed and ranges can be defined therefrom. Alternative methods for establishing the ranges are also possible.

All determined values of the function are subsequently output. Therefore, either the first or second process peak and the stretching work can then be linked as the guide variable “stretching force” to the input of the regulator. The value which best reflects the quality of the bottle can thus be selected depending on the process. Optionally, only one of these values can also be output and used as a guide variable, for example, only the stretching force.

It is possible to define a stretching force curve as a reference curve. This reference curve is provided, for example, in stored form and is subtracted, for example, from the presently detected curve. To eliminate influence of phase offset by way of the filter, the reference curve is filtered using the same filter constant, for example, before subtraction from the present curve. Furthermore, the resulting curve thus also remains free of noise. If the process and/or the stretching force curve is identical to the reference curve, the value 0 is output as the value for peak 1 and peak 2 and for the stretching work. It is thus not necessary upon use of the reference curve to explicitly specify a target value for the stretching force.

A change of the blowing pressure results in a change of the stretching force. It is therefore advantageous for a stable regulation if the regulator switches off upon change of the blowing pressure and the settings of the temperature control device are frozen. If one presumes that the temperature control of the preform has not changed in the time of the switching off, after the pressure change, the actual value for the stretching force can be assumed as the new target value and the regulation can be switched on again. This also applies for the change of another blowing parameter.

FIG. 9 shows the stretching force curve of a no-load stroke of a stretching rod. The readout algorithm has already subtracted the friction force during the constant travel. However a rising friction force remains on the travel section on which normally the stretching process takes place (see rising force in FIG. 9). Since the stations have different stiffnesses, the measured value for the stretching work varies. To avoid this behavior, no-load strokes can be used for referencing the measured system stretching drive. Subtracting a reference curve from a present stretching force curve can be implemented in the readout algorithm. This functionality can be utilized to subtract the no-load stroke curve of the respective station from the stretching force curve.

FIG. 14 shows a blowing station 3 in a perspective viewing direction from the front. It is recognizable from this illustration in particular that the stretching rod 11 is mounted by a stretching rod carrier 41. A forming station which forms and fills a preform simultaneously, could also be embodied in the same manner with respect to the stretching rod 11 and the stretching rod drive 49.

FIG. 14 also shows the arrangement of a pneumatic block 46 for the blowing pressure supply of the blowing station 3. The pneumatic block 42 is equipped with high pressure valves 43, which can be connected via fittings 44 to one or more pressure supplies. After blow molding of the container 12, blowing air to be discharged into an environment is firstly supplied to a silencer 45 via the pneumatic block 42.

The blowing procedure is typically carried out in such a manner that after the preform 14 is inserted into the blow mold 4, locking of the blowing station 3 occurs and firstly the stretching rod 11 is moved into the preform 14 with simultaneous blowing pressure assistance in such a way that the preform 14 does not shrink radially onto the stretching rod 11 due to the axial stretching. In this phase, a blowing pressure P1 is supplied. After the stretching procedure is completely carried out, the complete expansion of the container bubble into the final contour of the container 12 is performed by application of a higher blowing pressure P2. The maximum internal pressure P2 is maintained until the container 12 has reached a sufficient dimensional stability due to cooling. After reaching this dimensional stability, the blowing pressure supply is switched off and the stretching rod 11 is retracted again from the blow mold 4 and thus out of the blown container 12.

FIG. 14 also illustrates that the stretching rod carrier 41 is connected to a coupling element 46, which is guided at least in regions behind a cover 47. The coupling element 46 is positionable by a servo motor 49, for example, using a threaded rod (not recognizable in FIG. 14). The arrangement of the threaded rod, the mechanical positioning of the pneumatic block 42, and further details are explained, for example, in EP 2117806 B1 with respect to FIGS. 5 and 6 therein.

The threaded rod shown therein is connected via a coupling to a motor shaft of the servo motor 49. In the exemplary embodiment illustrated therein, the motor shaft and the threaded rod extend along a common longitudinal axis, so that the threaded rod is arranged as an extension of the motor shaft. In particular a gear-free connection of the motor shaft to the threaded rod is assisted in this way.

The coupling of the servo motor 49 via a threaded rod, a coupling element 46, and the stretching rod carrier 41 having the stretching rod 11 provides a system which is rigid in relation to external loads and nonetheless highly dynamic.

A present stretching force can be inferred in a simple manner from a metrological detection of the motor current of the servo motor 49. A regulation of the temperature control device can be performed, as explained above, in dependence on the stretching force metrologically detected by the detection of the motor current.

1-13. (canceled)

14: A method for operating a temperature control device to thermally condition preforms made of thermoplastic material in the temperature control device for a forming procedure in which the preforms are stretched axially using a stretching unit and formed into containers using a forming fluid supplied under a pressure into the preforms, the method comprising:
regulating heating power of the temperature control device with a heating regulator based on a metrologically determined guide value, said guide value being a metrologically detected value from which a stretching force exerted on the preform by the stretching unit is derivable.

15: The method according to claim 14, wherein the stretching unit is a stretching rod driven by an electrically operated stretching rod drive, and wherein current consumption of the electrically operated stretching rod drive is the metrologically detected value.

16: The method according to claim 15, wherein the electrically operated stretching rod drive is a linear motor.

17: The method according to claim 14, wherein the guide value is determined based on a defined range of or defined characteristic points of the metrologically detected value.

18: The method according to claim 15, wherein a value for a friction force of stretching rod movement is metrologically detected and taken into consideration in the determination of the guide value.

19: The method according to claim 14, wherein an external temperature of the preforms is metrologically detected and supplied to the heating regulator as a second guide value, wherein the temperature control device comprises heating units for heating the preforms and cooling units for applying a coolant medium to the preforms, wherein the cooling units are regulated by the heating regulator on the basis of the second guide value, and wherein the heating units are regulated by the heating regulator on the basis of the guide value determined from the metrologically detected value from which the stretching force exerted on the preform by the stretching unit is derivable.

20: The method according to claim 19, wherein the heating regulator is configured to prioritize the guide value determined from the metrologically detected value from which the stretching force exerted on the preform by the stretching unit is derivable over the second guide value.

21: A method for producing containers from preforms by forming the preforms into the containers using a forming fluid supplied under a pressure into the preforms after thermal conditioning of the preforms in a temperature control device, the method comprising operating the temperature control device according to the method of claim 14.

22: A temperature control device for thermally conditioning preforms made of a thermoplastic material for a subsequent forming procedure in which the preforms are formed into containers using a forming fluid supplied under a pressure into the preforms and in which the preforms are stretched axially by a stretching unit, the temperature control device comprising:
a heating regulator;
and a measuring unit;
wherein the heating regulator is arranged in a control loop with the measuring unit,
wherein the measuring unit is configured to metrologically detect a value from which a stretching force exerted on the preforms by the stretching unit is derivable, and
wherein the regulator is configured to regulate heating power of the temperature control device on the basis of the metrologically detected value.

23: The temperature control device according to claim 22, wherein the stretching unit is a stretching rod and comprises an electrically operated stretching rod drive, and wherein the measuring unit is configured to detect current consumption of the electrical stretching rod drive as the value.

24: The temperature control device according to claim 23, wherein the electrically operated stretching rod drive is a linear motor.

25: The temperature control device according to claim 22, wherein the heating regulator is configured to regulate according to an integral over a defined range or according to defined characteristic points of the metrologically detected value.

26: The temperature control device according to claim 22, further comprising a sensor for detecting an external temperature of the preforms and supplying measured values to the heating regulator as a second guide value, wherein the temperature control device comprises heating units for heating the preforms and cooling units for applying a coolant medium to the preforms, wherein the heating regulator is configured to regulate the cooling units on the basis of the second guide value, and wherein the heating regulator is configured to regulate the heating units on the basis of the metrologically detected value from which the stretching force exerted on the preforms by the stretching unit is derivable.

27: The temperature control device according to claim 26, wherein the heating regulator is configured to prioritize the guide value determined from the metrologically detected value from which the stretching force exerted on the preform by the stretching unit is derivable over the second guide value.

28: A machine for producing containers from preforms by stretching the preforms axially with a stretching unit and introducing a forming fluid under pressure into the preforms to form the containers, the machine comprising a temperature control device according to claim 22.
